(19) United States
(12) Patent Application Publication
(10) Pub. No.: US 2024/0397496 A1
(43) Pub. Date: Nov. 28, 2024

(54) WIRELESS COMMUNICATION DEVICE AND WIRELESS COMMUNICATION METHOD USING THE SAME

(71) Applicant: SAMSUNG ELECTRONICS CO., LTD., Suwon-si (KR)

(72) Inventors: Juyoung HYUN, Suwon-si (KR); Junseong Kim, Suwon-si (KR); Jongkeun Park, Suwon-si (KR)

(73) Assignee: SAMSUNG ELECTRONICS CO., LTD., Suwon-si (KR)

(21) Appl. No.: 18/638,237

(22) Filed: Apr. 17, 2024

(30) Foreign Application Priority Data
May 22, 2023 (KR) 10-2023-0065844
Aug. 2, 2023 (KR) 10-2023-0101006

(51) Int. Cl. H04W 72/0453; H04B 1/18

(52) U.S. Cl. CPC H04W 72/0453; H04B 1/18

(57) ABSTRACT

A wireless communication device includes a radio-frequency front end (RFFE) configured to receive an RF signal. The device also includes a radio-frequency integrated circuit (RFIC) configured to receive signals from the RFFE through a plurality of ports. The device includes at least one processor electrically connected to the RFIC and the RFFE. The at least one processor is configured to determine whether there is a port, capable of receiving a first signal and to allocate a first port, capable of receiving the first signal, to the first signal based on there being a port available. The at least one processor is also configured to determine whether there is a resource, capable of receiving the first signal, available among at least one resource connected to the first port, and to allocate a first resource, capable of receiving the first signal, to the first signal when there is resource available.

### CROSS-REFERENCE TO RELATED APPLICATION(S)

This U.S. non-provisional application claims priority under 35 USC § 119 to Korean Patent Application Nos. 10-2023-0065844, filed on May 22, 2023 and 10-2023-0101006, filed on Aug. 2, 2023, in the Korean Intellectual Property Office, the disclosures of which are herein incorporated by reference in their entirety.

### BACKGROUND

Example embodiments relate to a wireless communication device and a wireless communication method using the same.

A wireless communication device may modulate a radio-frequency (RF) signal by carrying data on a predetermined carrier, amplify the modulated RF signal, and transmit the amplified RF signal to a wireless communication network. In addition, the wireless communication device may receive the RF signal from the wireless communication network, amplify the received RF signal, and demodulate the amplified RF signal.

For example, a wireless communication device may support carrier aggregation (CA), which is transmission and reception of RF signals modulated on multiple carriers, to transmit and receive more data. By using carrier aggregation supporting channels of a plurality of frequency bands, the amount of data transmitted and received by the wireless communication device may be increased.

A wireless communication device should allocate a port and a resource, which may transmit and receive an RF signal, in response to each combination of a plurality of frequency bands included in the RF signal to support carrier aggregation.

### SUMMARY

Example embodiments provide a wireless communication device and a wireless communication method, in which a port and a resource are allocated to a signal corresponding to each of a plurality of frequency bands to determine whether the wireless communication device supports a radio-frequency (RF) signal including corresponding signals.

Provided herein is a wireless communication device including: a radio-frequency front end (RFFE) configured to receive an RF signal, including signals respectively corresponding to a plurality of frequency bands, through carrier aggregation; a radio-frequency integrated circuit (RFIC) configured to receive the signals from the RFFE through at least a portion of a plurality of electrical paths and a plurality of ports connected to the plurality of electrical paths; and at least one processor electrically connected to the RFIC and the RFFE. The at least one processor is configured to: determine whether there is a port, capable of receiving a first signal corresponding to a first frequency band, among the signals, in the RFIC; allocate a first port, capable of receiving the first signal, to the first signal based on the first port being available; determine whether there is a resource, capable of receiving the first signal, among at least one resource connected to the first port; and allocate a first resource, capable of receiving the first signal, to the first signal based on the first resource being available.

Also provided herein is a wireless communication method including: receiving a radio-frequency (RF) signal including signals, the signals respectively corresponding to a plurality of frequency bands; determining whether there is a port, capable of receiving a first signal included in the RF signal, among a plurality of ports included in a radio-frequency integrated circuit (RFIC), in response to transmitting the first signal from a radio-frequency front end (RFFE) to the RFIC; allocating a first port to the first signal based on there is the first port, capable of receiving the first signal, among the plurality of ports; determining whether there is a resource, capable of receiving the first signal, among at least one resource connected to the first port; and allocating a first resource to the first signal based on the first resource, capable of receiving the first signal, being available among the at least one resource.

Also provided herein is a wireless communication device including: a radio-frequency front end (RFFE) configured to receive an RF signal, including signals respectively corresponding to a plurality of frequency bands, through carrier aggregation; a radio-frequency integrated circuit (RFIC) including a plurality of ports connected to the RFFE through a plurality of electrical paths; and at least one processor electrically connected to the RFIC and the RFFE. The at least one processor is configured to: allocate a first port, capable of receiving a first signal corresponding to a first frequency band, among the plurality of ports, to the first signal; and allocate a first resource, capable of receiving the first signal, among at least one resource connected to the first port, to the first signal, wherein the first port is allocated to the first signal.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a block diagram of a wireless communication device according to an example embodiment.

FIG. 2A is a circuit diagram illustrating an example of the wireless communication device of FIG. 1.

FIG. 2B is a circuit diagram illustrating an example of a first resource of the wireless communication devices of FIG. 2A.

FIG. 3A is a flowchart illustrating an operation, in which a wireless communication device allocates a port and a resource to a first signal, according to an example embodiment.

FIG. 3B is a flowchart illustrating an operation, in which a wireless communication device transmits and receives a first signal using a first port and a first resource, according to an example embodiment.

FIG. 3C is a flowchart illustrating an operation, in which a wireless communication device allocates ports and resources to signals of an RF signal other than a first signal, according to an example embodiment.

FIG. 4 is a flowchart illustrating an operation of determining whether a wireless communication device according to an example embodiment is capable of receiving an RF signal through an RFIC based on frequency information of the RF signal and a predetermined set value.

FIG. 5 is a flowchart illustrating an operation in which a wireless communication device according to an example embodiment controls a switching circuit to connect a first filter, through which a first signal passes, and a first electrical path connected to a first port.

FIG. 6 is a flowchart illustrating an operation of allocating first to fourth ports and first to fourth resources to an RF signal having an additional path component, according to an example embodiment.

### DETAILED DESCRIPTION

Hereinafter, example embodiments will be described with reference to the accompanying drawings.

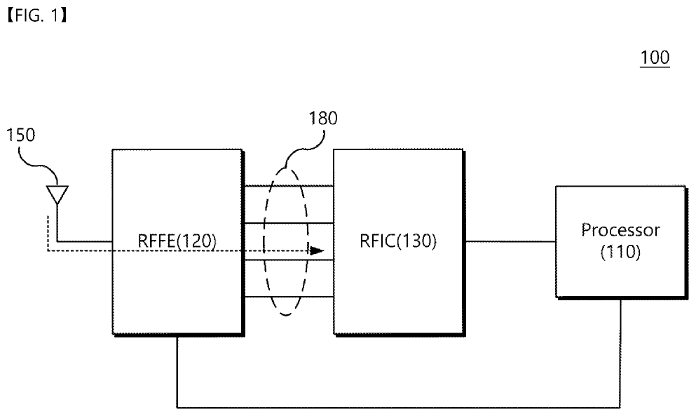

FIG. 1 is a block diagram of a wireless communication device according to an example embodiment.

Referring to FIG. 1, a wireless communication device 100 according to an example embodiment may include an antenna 150, a radio-frequency front end (RFFE) 120, a radio-frequency integrated circuit (RFIC) 130, and a processor 110.

According to one or more embodiments, the wireless communication device 100 may include various types of devices. The wireless communication device 100 may include, for example, a portable communication device (for example, a smartphone), a computer device, a portable multimedia device, a portable medical device, a camera, or a wearable device. However, the wireless communication device 100 according to an example embodiment is not limited to the above-described devices.

The wireless communication device 100 may include an antenna 150 receiving an RF signal including signals corresponding to a plurality of frequency bands. Accordingly, the wireless communication device 100 example embodiments may be referred to as an antenna device including an antenna 150 or a wireless transceiver.

According to an example embodiment, the wireless communication device 100 may support carrier aggregation (CA) using a plurality of carriers. For example, the wireless communication device 100 may receive signals corresponding to a plurality of frequency bands merged into a radio-frequency (RF) signal through carrier aggregation (CA).

The wireless communication device 100 may include an RFFE 120 receiving an RF signal through an antenna 150.

The RFFE 120 according to an example embodiment may receive an RF signal, including signals corresponding to a plurality of frequency bands, through the antenna 150.

The RFFE 120 may perform preprocessing on a signal received through the antenna 150. For example, the RFFE 120 may preprocess the RF signal received through the antenna 150.

To this end, the RFFE 120 may include at least a portion of a phase shifter, a band pass filter, and a switching circuit, which are connected to the antenna 150.

In addition, the RFFE 120 may be connected to the RFIC 130 through a plurality of electrical paths 180. Accordingly, the RFFE 120 may transmit the RF signal, received from the antenna 150, to the RFIC 130 through at least a portion of the plurality of electrical paths 180.

The wireless communication device 100 may include an RFIC 130 connected to the RFFE 120 through the plurality of electrical paths 180.

For example, the wireless communication device 100 may include an RFIC 130 converting a baseband signal into an RF signal or converting an RF signal into a baseband signal.

For example, the RFIC 130 may convert the RF signal, pre-processed through the RFFE 120, into a baseband signal to be processed by the processor 110, during reception.

For example, the RFIC 130 may convert the baseband signal, generated by processor 110, into an RF signal of about 700 MHz to about 3 GHz used in a first network (for example, a legacy network) during transmission.

For example, the RFIC 130 may convert the baseband signal, generated by the processor 110, into an RF signal in a Sub6 band (about 6 GHz or less) used for a second network (for example, a 5G network) during transmission.

For example, RFIC 130 may convert the baseband signal, generated by processor 110, into an RF signal in a 5G Above5 band (for example, about 6 GHz to about 60 GHz) used for a third network (for example, a 5G network) during transmission.

The RFIC 130 may include a plurality of ports, respectively connected to the plurality of electrical paths 180. Accordingly, the RFIC 130 may receive signals, included in the RF signal, from the RFFE 120 using at least a portion of the plurality of ports connected to the plurality of electrical paths 180.

In addition, the RFIC 130 may include at least one resource connected to at least a portion of the plurality of ports. Accordingly, the RFIC 130 may receive each of the signals, included in the RF signal, using the plurality of ports and at least one resource connected to the plurality of ports.

The wireless communication device 100 may include a processor 110 electrically connected to the RFFE 120 and the RFIC 130.

The processor 110 may execute software (or a program) to control one or more other component (for example, the RFFE 120 or the RFIC 130) of the wireless communication device 100, and may perform various data processing or calculations. The processor 110 may include a central processing unit or a microprocessor, and may control the overall operation of the wireless communication device 100. Accordingly, operations performed by the wireless communication device 100 may be understood as being performed under the control of the processor 110.

According to an example embodiment, the processor 110 may include an algorithm for controlling at least a portion of the RFFE 120 and the RFIC 130. For example, the algorithm may be a software code programmed in processor 110. For example, the algorithm may be a hard code hard-coded in the processor 110, but example embodiments are not limited thereto.

The processor 110 may determine whether a port and a resource in the RFIC 130 are capable of being allocated to each of the signals included in the RF signal based on the algorithm.

For example, when the processor 110 is capable of allocating the port and resource in the RFIC 130 to each of the signals included in the RF signal, the processor 110 may determine that the wireless communication device 100 is capable of supporting communication using the RF signal.

Moreover, the processor 110 may receive each of the signals, included in the RF signal, using the port and resource allocated to each signal. In addition, the processor 110 may output an output value including information that the wireless communication device 100 is capable of supporting communication through the RF signal.

For example, when the processor 110 is incapable of allocating the port and resource in the RFIC 130 to at least a portion of the signals included in the RF signal, the processor 110 may determine that the wireless communication device 100 is incapable of supporting communication through the RF signal.

Moreover, the processor 110 may output an output value including information that the wireless communication device 100 is incapable of supporting the communication using the RF signal.

Referring to the above-described configuration, the processor 110 according to an example embodiment may allocate a port and a resource to each of the signals included in the RF signal received through carrier aggregation (CA). Thus, the processor 110 may determine whether the wireless communication device 100 is capable of supporting the communication using the RF signal.

As a result, the wireless communication device 100 according to the present embodiment may save costs and resources consumed to determine whether the wireless communication device 100 is capable of supporting the communication using the RF signal including signals in a plurality of frequency bands.

In addition, the wireless communication device 100 according to the present embodiment may save a storage space of a memory required to store data for determining whether the wireless communication device 100 is capable of supporting communication using the RF signal including signals in a plurality of frequency bands.

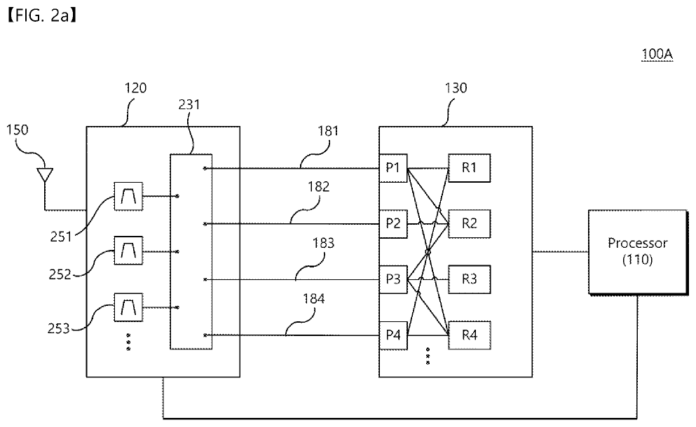

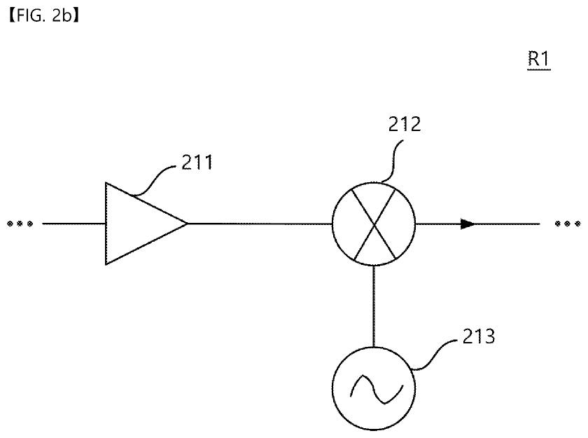

FIG. 2A is a circuit diagram illustrating an example of the wireless communication device of FIG. 1, and FIG. 2B is a circuit diagram illustrating an example of a first resource of the wireless communication devices of FIG. 2A.

Referring to FIGS. 2A and 2B together, a wireless communication device 100A according to an example embodiment may allocate at least a portion of a plurality of ports P1, P2, P3, and P4 and a plurality of resources R1, R2, R3, and R4 to each of signals included in an RF signal.

Referring to FIG. 2A, the RFFE 120 according to an example embodiment may include a first filter 251, a second filter 252, and the third filter 253 allowing a signal corresponding to at least one predetermined frequency band, among the signals included in the RF signal, to pass therethrough.

For example, the RFFE 120 may include the first filter 251 allowing signals in B39, B25, B70, and B3 bands of a long term evolution (LTE) network, among the signals included in the RF signal, to pass therethrough.

In addition, for example, the RFFE 120 may include the second filter 252 allowing signals in the B66, B34, and B1 bands of the LTE network, among signals included in the RF signal, to pass therethrough.

In addition, for example, the RFFE 120 may include the third filter 253 allowing signals in a B32 band of the LTE network and n75 and n76 bands of a new radio (NR) network, among the signals included in the RF signal, to pass therethrough.

However, the number of filters, included in the RFFE 120, and the frequency band, set to allow each of the filters to pass therethrough, are not limited to the above-described examples.

The RFFE 120 may include a switching circuit 231 connecting the plurality of filters 251, 252, and 253 to the plurality of electrical paths 181, 182, 183, and 184, respectively. In this case, the processor 110 may control the switching circuit 231 to transmit signals, respectively output from the plurality of filters 251, 252, and 253, to the plurality of electrical paths 181, 182, 183, and 184.

For example, the processor 110 may control the switching circuit 231 to connect the first filter 251 and the first electrical path 181. Thus, the processor 110 may transmit signals, output from the first filter 251, to the first electrical path 181.

For example, the processor 110 may control the switching circuit 231 to connect the second filter 252 and the third electrical path 183. Thus, the processor 110 may transmit signals, output from the second filter 252, to the third electrical path 183.

Referring to FIG. 2A, the switching circuit 231 may be referred to as including a 3×4 switch including three input terminals and four output terminals, but example embodiments are not limited thereto. The switching circuit 231 may be referred to as, for example, a multiplexer (MUX) including a plurality of input terminals and a plurality of output terminals.

The RFIC 130 may include a plurality of ports P1, P2, P3, and P4, respectively connected to a plurality of electrical paths 181, 182, 183, and 184.

For example, the RFIC 130 may include a first port P1 connected to a first electrical path 181, a second port P2 connected to a second electrical path 182, and a third electrical path 183 connected to a third port P3, and a fourth port P4 connected to a fourth electrical path 184. However, the number of ports included in the RFIC 130 and a connection relationship between the ports and the electrical paths are not limited to the above-described examples.

The RFIC 130 may receive signals transmitted through the plurality of electrical paths 181, 182, 183, and 184 using the plurality of ports P1, P2, P3, and P4.

For example, the RFIC 130 may receive signals, transmitted through the first electrical path 181, through the first port P1. In addition, the RFIC 130 may receive signals, transmitted through the second electrical path 182, through the second port P2. In addition, the RFIC 130 may receive signals, transmitted through the third electrical path 183, through the third port P3. In addition, the RFIC 130 may receive signals, transmitted through the fourth electrical path 184, through the fourth port P4.

Moreover, the RFIC 130 may include a plurality of resources R1, R2, R3, and R4, respectively connected to at least a portion of the plurality of ports P1, P2, P3, and P4.

For example, the RFIC 130 may include a first resource R1 connected to the first port P1 and the fourth port P4. In addition, the RFIC 130 may include a second resource R2 connected to the first port P1, the second port P2, and the third port P3. In addition, the RFIC 130 may include a third resource R3 connected to the third port P3. In addition, the RFIC 130 may include a fourth resource R4 connected to the first port P1, the third port P3, and the fourth port P4. However, the number of resources included in the RFIC 130 and a connection relationship between the resources and the ports are not limited to the examples described above.

Referring to FIG. 2B, the first resource R1 according to one embodiment may include an amplifier 211, a mixer 212, and a local oscillator LO.

According to an example embodiment, the RFIC 130 may convert a signal, received through at least a portion of the plurality of ports P1, P2, P3, and P4, into a baseband signal through the first resource R1 and then output the baseband signal.

For example, the RFIC 130 may transmit a signal, input to the first resource R1, to the mixer 212 through the amplifier 211. In addition, the RFIC 130 may mix a signal transmitted from the amplifier 211 and a signal of a specific frequency band transmitted from the local oscillator 213 through the mixer 212 and then output the mixed signal. In this case, the signal output from the mixer 212 may be understood as a baseband signal.

Accordingly, the RFIC 130 may convert a signal received through a port connected to the first resource R1, among the plurality of ports P1, P2, P3, and P4, into a baseband signal using the first resource R1. A port is a circuit connection for an RF signal. For example, a port may be configured with suitable impedance, transmission and reflection characteristics with respect to a frequency band. A port with suitable characteristics for a particular frequency band may be described as capable (with respect to that particular frequency band). Moreover, the RFIC 130 may transmit the converted baseband signal to the processor 110.

However, the configuration of the first resource R1 is not limited to that illustrated in FIG. 2B.

According to an example embodiment, the first resource R1 may further include at least a portion of an analog-to-digital converter (ADC), connected to the mixer 212, and an analog baseband (ABB) converter.

The number of resources and ports and a connection relationship between the resources and the ports are not limited to the above-described example, and the RFIC 130 may include a various number of resources and ports. The resources and the ports may be understood to be connected through various connection relationships.

Accordingly, the RFIC 130 may receive signals, transmitted through the plurality of electrical paths 181, 182, 183, and 184 using the plurality of ports P1, P2, P3, and P4 and the plurality of resources R1, R2, R3, and R4, respectively connected to the plurality of ports P1, P2, P3, and P4.

According to an example embodiment, the processor 110 may determine whether the plurality of ports P1, P2, P3, and P4 and the plurality of ports P1, P2, P3, and P4 are capable of being allocated to each of the signals transmitted through the plurality of electrical paths 181, 182, 183, and 184.

For example, the processor 110 may determine whether the RFIC is in a state in which the plurality of ports P1, P2, P3, and P4 and the plurality of resources R1, R2, R3, and R4 are each capable of receiving signals output from the plurality of filters 251, 252, and 253.

The processor 110 may determine whether the plurality of ports P1, P2, P3, and P4 are in a state in which they are receiving signals output from the plurality of filters 251, 252, and 253.

The processor 110 may determine whether there is a port, capable of receiving signals output from the first filter 251, among the plurality of ports P1, P2, P3, and P4.

For example, when each of the plurality of ports P1, P2, P3, and P4 is receiving signals output from filters other than the first filter 251, the processor 110 may determine that there is no port, capable of receiving the signals output from the first filter 251, among the plurality of ports P1, P2, P3, and P4.

For example, when among the plurality of ports P1, P2, P3, and P4, the first port P1 is not receiving signals, the processor 110 may determine that the first port P1 is in a state in which signals output from the first filter 251 are capable of being received.

In addition, the processor 110 may determine, for signals output from each of the second filter 252 and the third filter 253, whether there is a port, capable of the corresponding signals, among the plurality of ports P1, P2, P3, and P4.

Moreover, the processor 110 may allocate a port, capable of receiving a corresponding signal, among the plurality of ports P1, P2, P3, and P4, to each of the signals output from the plurality of filters 251, 252, and 253.

For example, when the first port P1 is determined to be in a state in which signals output from the first filter 251 are being capable of being received, the processor 110 may allocate the first port P1 to the signals output from the first filter 251.

In addition, the processor 110 may determine whether the RFIC 130 is in a state in which each of the plurality of resources R1, R2, R3, and R4 is capable of receiving signals output from the plurality of filters 251, 252, and 253.

For example, when signals in four bands (for example, B39, B25, B70, and B3 bands) output from the first filter 251 are received through the first port P1, the processor 110 may determine that the RFIC 130 is incapable of receiving signals output from the first filter 251 through the three resources R1, R2, and R4 connected to the first port P1.

For example, when signals in three bands (for example, B66, B34, and B1 bands) output from the second filter 252 are received through the third port P3, the processor 110 may determine that the RFIC 130 is capable of receiving signals output from the second filter 252 through the three resources R2, R3, and R4 connected to the third port P3.

The processor 110 may allocate, to signals output from the plurality of filters 251, 252, and 253, resources connected to ports to which the signals are connected, respectively.

For example, when the RFIC 130 is capable of receiving signals output from the second filter 252 through resources connected to the third port P3, the processor 110 may allocate the resources, connected to the third port P3, to each of the signals output from the second filter 252. For example, the processor 110 may allocate the second resource R2, the third resource R3, and the fourth resource R4 to signals in the B66, B34, and B1 bands output from the second filter 252, respectively.

The processor 110 may receive signals, output from the plurality of filters 251, 252, and 253, using a port and a resource allocated to each of the signals transmitted through the plurality of electrical paths 181, 182, 183, and 184

For example, the wireless communication device 100A according to an example embodiment may receive an RF signal, including signals in a plurality of frequency bands, based on carrier aggregation (CA) using ports and resources, respectively allocated to the signals.

When a port and a resource are allocated to each of the signals included in the RF signal, the processor 110 may determine that the wireless communication device 100A is capable of supporting communication using the RF signal.

Referring to the above-described configurations, the processor 110 may allocate a port and a resource, capable of receiving a corresponding signal, to each of the signals in the plurality of frequency bands included in the RF signals based on carrier aggregation (CA). In addition, the processor 110 may determine whether the wireless communication device 100A is capable of supporting communication using the RF signal including signals in a plurality of frequency bands.

With the above-described configurations, the wireless communication device 100A according to the present embodiment may save costs and resources consumed to determine whether the wireless communication device 100 is capable of supporting communication using the RF signal including signals in a plurality of frequency bands.

In addition, the wireless communication device 100A according to the present embodiment may saves a storage space of a memory required to store data for determining whether the wireless communication device 100 is capable of supporting communication using the RF signal including signals in a plurality of frequency bands.

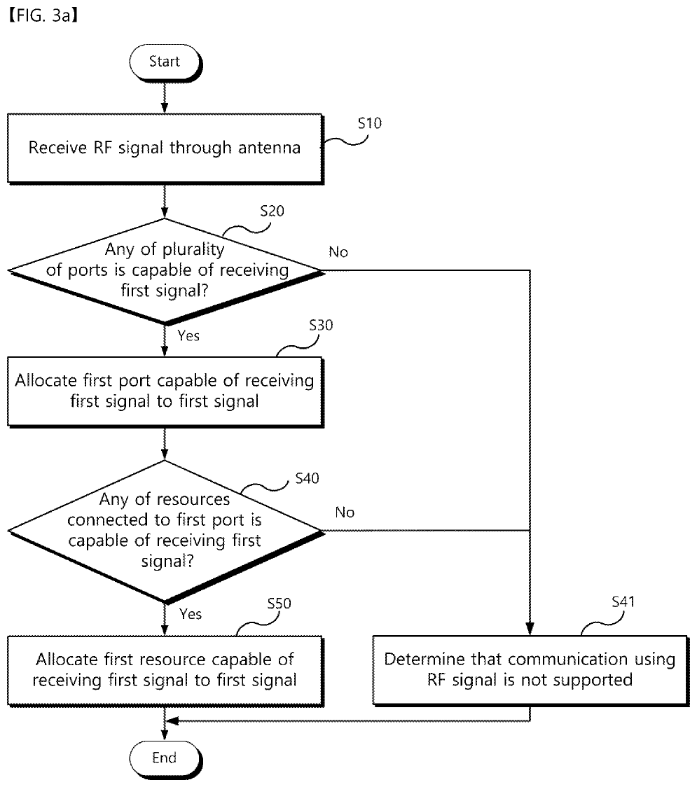

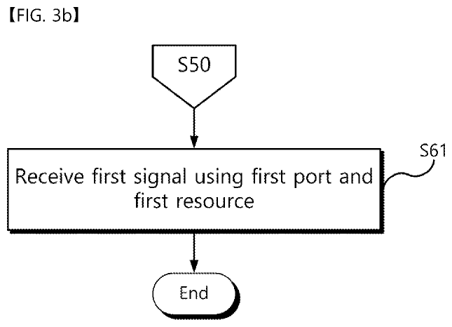

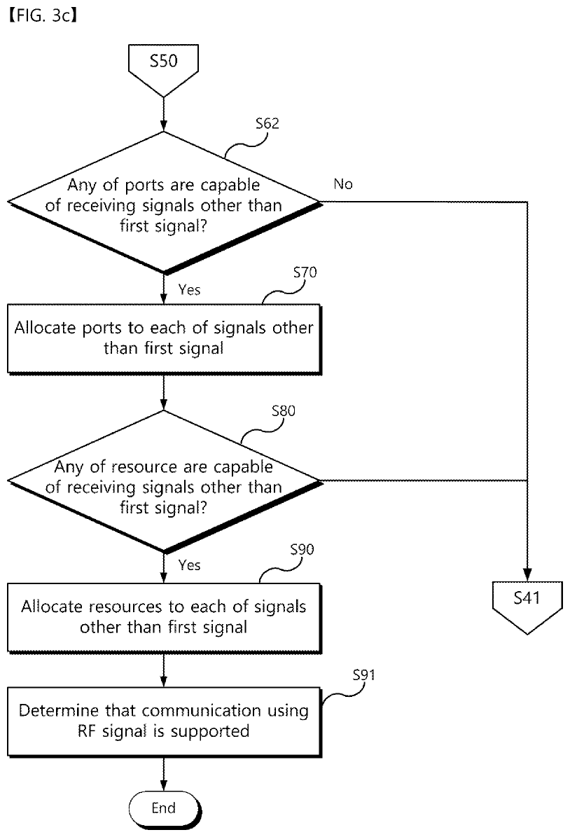

FIG. 3A is a flowchart illustrating an operation, in which a wireless communication device allocates a port and a resource to a first signal, according to an example embodiment. FIG. 3B is a flowchart illustrating an operation, in which a wireless communication device transmits and receives a first signal using a first port and a first resource, according to an example embodiment. FIG. 3C is a flowchart illustrating an operation, in which a wireless communication device allocates ports and resources to signals of an RF signal other than a first signal, according to an example embodiment.

Referring to FIGS. 3A to 3C together, a processor 110 according to an example embodiment may allocate a port of an RFIC 130 and a resource, connected to the port, to each of the signals corresponding to a plurality of frequencies. The wireless communication device and the processor of FIGS. 3A to 3C may be understood to correspond to the wireless communication device 100 and processor 110 of FIG. 1, respectively.

In operation S10, the processor 110 may receive an RF signal through the antenna 150. For example, the processor 110 may receive an RF signal, including signals corresponding to a plurality of frequency bands, through the antenna 150.

In this case, the RF signal received through the antenna 150 may include a plurality of signals corresponding to a plurality of frequency bands based on carrier aggregation (CA). For example, the RF signal may include a first signal corresponding to a first frequency band.

In operation S20, the processor 110 may determine whether there is a port, capable of receiving the first signal, among the plurality of ports P1, P2, P3, and P4.

For example, the processor 110 may determine whether there is a port, capable of receiving the first signal, among the plurality of ports P1, P2, P3, and P4 included in the RFIC 130. For example, the processor 110 may sequentially identify whether the first port P1 to the fourth port P4 are in a state in which they are capable of receiving a first signal.

According to an example embodiment, the processor 110 may determine whether there is a port is not receiving a signal from an RFFE 120, among a plurality of ports P1, P2, P3, and P4, in response to the first signal being transmitted to the RFIC 130.

For example, when the first signal is transmitted to the RFIC 130 and each of the plurality of ports P1, P2, P3, and P4 is receiving signals other than the transmitted first signal, the processor 110 may determine that there is no port, capable of receiving the first signal, among the ports P1, P2, P3, and P4.

For example, when the first signal is transmitted to the RFIC 130 and at least a portion of the plurality of ports P1, P2, P3, and P4 is not receiving signals from the RFFE 120, the processor 110 may determine that there is a port, capable of receiving the first signal.

In addition, when there is a port, capable of receiving the first signal, among the plurality of ports P1, P2, P3, and P4, the processor 110 may determine that the port is capable of being allocated to the first signal. For example, when there is a port available and capable of receiving the first signal, the processor 110 may determine that there is a port available for being allocated to the first signal.

In operation S30, the processor 110 may allocate a first port, capable of receiving the first signal, to the first signal.

For example, when among the plurality of ports P1, P2, P3, and P4, the first port P1 is determined to be capable of receiving the first signal, the processor 110 may allocate the first port P1 to the first signal.

For example, when among the plurality of ports P1, P2, P3, and P4, the second port P2 is determined to be capable of receiving the first signal, the processor 110 may allocate the second ports P2 to the first signal.

For example, the processor 110 may allocate a port determined to be capable of receiving the first signal, among the plurality of ports P1, P2, P3, and P4, to the first signal.

In operation S40, the processor 110 may determine whether there is a resource, capable of receiving the first signal, among the plurality of resources R1, R2, R3, and R4.

For example, when the first port P1 is allocated to the first signal, the processor 110 may determine whether there is a resource, capable of receiving the first signal, among resources (for example, R1, R2, and R4) connected to the first port P1.

For example, when each of the resources R1, R2, and R4 connected to the first port P1 is receiving the first signal in the state in which the first port P1 is allocated to the first signal, the processor 110 may determine that there is no resource, capable of receiving the first signal, among the resources R1, R2, and R4 connected to the first port P1.

For example, when at least a portion of the resources R1, R2, and R4 connected to the first port P1 is not receiving a signal in the state in which the first port P1 is allocated to the first signal, the processor 110 may determine that there is a resource, capable of receiving the first signal.

In addition, when there is a resource, capable of receiving the first signal, among the plurality of resources R1, R2, R3, and R4, the processor 110 may determine that a resource is capable of being allocated to the first signal.

In operation S50, the processor 110 may allocate the first resource R1, capable of receiving the first signal, to the first signal.

For example, when among the resources R1, R2, and R4 connected to the first port P1, the first resource R1 is determined to be capable of receiving the first signal, the processor 110 may allocate the first resource R1 to the first signal.

According to an example embodiment, when among the resources R1, R2, and R4 connected to the first port P1, the second resource R2 is determined to be capable of receiving the first signal, the processor 110 may allocate the second resource R2 to the first signal.

For example, the processor 110 may allocate a resource, capable of receiving the first signal, to the first signal from among the resources connected to the port to which the first signal is allocated.

In operation S41, the processor 110 may determine that the wireless communication device 100 does not support the communication using the RF signal.

For example, when there is no port, capable of receiving the first signal, among the plurality of ports P1, P2, P3, and P4, the processor 110 according to an example embodiment may determine that the wireless communication device 100 does not support the communication using the RF signal.

In this case, the processor 110 may output a predetermined first output value. For example, the first output value may be referred to as an output value including information that the wireless communication device 100 is incapable of supporting the communication using the RF signal due to failure to allocate a port to the first signal transmitted to the RFIC 130.

In addition, when it is determined that there is no resource, capable of receiving the first signal, among the resources R1, R2, and R4 connected to the first port P1, the processor 110 may determine that the wireless communication device 100 does not support the communication using the RF signal.

In this case, the processor 110 may output, for example, a predetermined second output value. For example, the second output value may be referred to as an output value including information that the wireless communication device 100 is incapable of supporting the communication using the RF signal due to failure to allocate a resource to the first signal transmitted to the RFIC 130.

According to an example embodiment, the first output value and the second output value may be understood as the same output value. For example, the first output value and the second output value may be referred to as output values including information that the wireless communication device 100 is incapable of supporting the communication using the RF signal.

Referring to the above-described configurations, the processor 110 may determine an RF signal, including signals corresponding to a plurality of frequency bands, is being capable of being received based on carrier aggregation (CA).

Thus, the processor 110 may determine whether the wireless communication device 100 is capable of supporting communication using the RF signal including signals in a plurality of frequency bands.

As a result, the wireless communication device 100 according to the present embodiment may save costs and resources consumed to determine whether the wireless communication device 100 is capable of supporting the communication using the RF signal including signals in a plurality of frequency bands.

In addition, the wireless communication device 100 according to the present embodiment may save a storage space of a memory required to store data for determining whether the wireless communication device 100 is capable of supporting the communication using the RF signal including signals in a plurality of frequency bands.

Referring to FIG. 3B, a processor 110 according to an example embodiment may receive a first signal using a first port P1 and a first resource R1 allocated to the first signal.

In operation S61, the processor 110 may receive the first signal using the first port P1 and the first resource R1 in response to the first port P1 and the first resource R1 being allocated to the first signal.

According to an example embodiment, when a third port P3 and a fourth resource R4 are allocated to the first signal, the processor 110 may receive the first signal using the third port P3 and the fourth resource R4.

For example, the processor 110 may receive the first signal using the port and resources allocated to the first signal.

Referring to FIG. 3C, a processor 110 according to an example embodiment may allocate a port and a resource to each of the signals of an RF signal other than a first signal.

For example, the RF signal may include a second signal corresponding to a second frequency band, a third signal corresponding to a third frequency band, and a fourth signal corresponding to a fourth frequency band. However, the number of signals and frequency bands, included in the RF signal, are not limited to the above-described examples.

In operation S62, the processor 110 may determine whether there is a port, capable of receiving the signals of the RF signal other than the first signal.

For example, when the first port P1 and the first resource R1 are allocated to the first signal, the processor 110 may determine whether there is a port, capable of receiving the signals of the RF signal other than the first signal, among a plurality of ports P1, P2, P3, and P4.

To this end, when the signals of the RF signal, other than the first signal, are transmitted to the RFIC 130, the processor 110 may determine whether there is a port, which is not receiving a signal from the RFFE 120, among the plurality of ports P1, P2, P3, and P4.

For example, when the second signal is transmitted to the RFIC 130 and each of the plurality of ports P1, P2, P3, and P4 is receiving signals other than the transmitted second signal, the processor 110 may determine that there is no port, capable of receiving the second signal, among the ports P1, P2, P3, and P4.

For example, when a third signal is transmitted to the RFIC 130 and at least a portion of the plurality of ports P1, P2, P3, and P4 is not receiving a signal, the processor 110 may determine that there is a port, capable of receiving the third signal.

In operation S70, the processor 110 may allocate a port to each of the signals of the RF signal other than the first signal.

For example, when there is a port, capable of receiving the signals of the RF signal other than the first signal, the processor 110 may allocate a port to each of the signals other than the first signal.

For example, the processor 110 may allocate a third port P3 to the second signal and the third signal, and may allocate the fourth port P4 to a fourth signal.

In operation S41, when there is no port, capable of receiving at least a portion of the signals of the RF signal other than the first signal, the processor 110 may determine that the wireless communication device 100 does not support communicate using the RF signal.

In this case, the processor 110 may output a predetermined first output value. For example, the first output value may be referred to as an output value including information that the wireless communication device 100 is incapable of supporting the communication using the RF signal due to failure to allocate a port to the signal transmitted to the RFIC 130.

In operation S80, the processor 110 may determine whether there is a resource, capable of receiving each of the signals of the RF signal other than the first signal, among the plurality of resources R1, R2, R3, and R4.

For example, when a port is allocated to each of the signals included in the RF signal, the processor 110 may determine whether there is a resource, capable of receiving the signal, among the resources connected to the port allocated to each of the signals.

For example, when each of the resources R2, R3, and R4 is receiving the signals other than the second signal in the state in which the third port P3 is allocated to the second signal, the processor 110 may determine that there is no resource, capable of receiving the second signal, among the resources R2, R3, and R4 connected to the third port P3.

For example, when a portion of the resources R2, R3, and R4 connected to the third port P3 is not receiving a signal in the state in which the third port P3 is allocated to the second signal, the processor 110 may determine that there is a resource, capable of receiving the second signal.

In operation S90, the processor 110 may allocate a resource, capable of receiving a corresponding signal, to each of the signals of RF signals other than the first signal.

For example, when it is determined that there is a resource, capable of receiving a corresponding signal for each of the signals of the RF signal other than the first signal, the processor 110 may allocate a resource, capable of receiving the signal, to each of the signals.

In operation S41, when it is determined that there is no resource, capable of receiving a corresponding signal, among the resources connected to the port allocated to each of the signals, the processor 110 may determine that the wireless communication device 100 does not support communication using the RF signal.

In this case, the processor 110 may output a predetermined second output value. For example, the second output value may be referred to as an output value including information that the wireless communication device 100 is incapable of supporting communication using an RF signal due to failure to allocate a resource to the signal transmitted to the RFIC 130.

In operation S91, the processor 110 may determine that the wireless communication device 100 supports the communication using the RF signal.

For example, the processor 110 may determine that the wireless communication device 100 supports the communication using the RF signal in response to a port and a resource being allocated to each of the signals included in the RF signal.

For example, the processor 110 may output a third output value including information that the wireless communication device 100 supports the communication using the RF signal.

Referring to the above-described configurations, the processor 110 may determine an RF signal, including signals in a plurality of frequency bands, is being capable of being received based on carrier aggregation (CA).

Thus, the processor 110 may determine whether the wireless communication device 100 is capable of supporting the communication using the RF signal including the signals in the plurality of frequency bands.

The wireless communication device 100 according to the present embodiment may save costs and resources consumed to determine whether the wireless communication device 100 is capable of supporting the communication using the RF signal including the signals in the plurality of frequency bands.

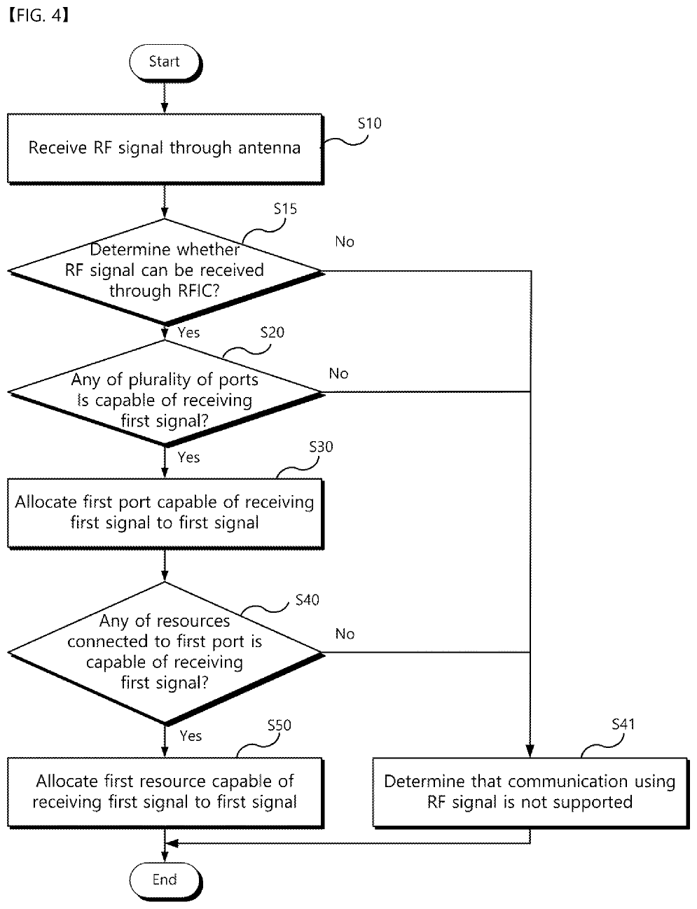

FIG. 4 is a flowchart illustrating an operation of determining whether a wireless communication device according to an example embodiment is capable of receiving an RF signal through an RFIC based on frequency information of the RF signal and a predetermined set value.

Referring to FIG. 4, the processor 110 according to an example embodiment may determine whether a wireless communication device is capable of receiving an RF signal through an RFIC 130 in response to receiving the RF signal through carrier aggregation (CA).

However, at least a portion of the operations illustrated in FIG. 4 may be referred to as the same as the operations illustrated in FIG. 3A. Accordingly, the same reference numerals are used for the same or substantially the same components as described above, and redundant descriptions are omitted.

In operation S15, the processor 110 may determine whether an RF signal is capable of being received through the RFIC 130.

For example, the processor 110 may determine whether the RF signal is capable of being received through the RFIC 130, based on frequency information included in the RF signal and a predetermined set value.

According to an example embodiment, the processor 110 may identify frequency information of signals included in the RF signal in response to receiving the RF signal including the signals corresponding to a plurality of frequency bands through the antenna 150 and the RFFE 120. For example, the frequency information may include information on a frequency band of each of the signals included in the RF signal, but example embodiments are not limited thereto.

The processor 110 may compare frequency information, included in the RF signal, and the predetermined set value.

For example, the set value may include at least one of the number of ports included in the RFIC 130, the number of resources included in the RFIC 130, information associated with a frequency band received through the RFIC 130, and an indication or information on whether the RFIC 130 supports allocation of an additional path (for example, 4RX path). However, the type and configuration of the set value are not limited thereto.

For example, the wireless communication device 100 may further include a memory storing the set value.

The processor 110 may compare the frequency information, included in the RF signal, and the predetermined set value to determine whether the RF signal is capable of being received through the RFIC 130.

For example, when the number of signals in a frequency band included in the RF signal is larger than the number of ports included in the RFIC 130, the processor 110 may determine that the RF signal is incapable of being received through the RFIC 130.

For example, when the number of signals in a frequency band included in the RF signal is larger than the number of resources included in the RFIC 130, the processor 110 may determine that the RF signal is capable of being received through the RFIC 130.

For example, when there is a signal in a frequency band other than the frequency band that the RFIC 130 is capable of receiving, among the signals included in the RF signal, the processor 110 may determine that the RF signal is incapable of being received through the RFIC 130.

For example, when there is a signal including an additional path component, among the signals included in the RF signal, and the RFIC 130 does not support additional path allocation based on a set value, the processor 110 may determine that the RF signal is incapable of being received.

However, the operation of comparing the frequency information and the set value, included in the RF signal, to determine whether the RF signal is capable of being received through the RFIC 130 is not limited to the above-described example.

Moreover, when it is determined that the wireless communication device 100 is capable of receiving an RF signal through the RFIC 130, the processor 110 may allocate a port and a resource to each of the signals included in the RF signal.

In operation S41, when it is determined that the RF signal is incapable of being received through the RFIC 130, the processor 110 may determine that the wireless communication device 100 does not support communication using the RF signal.

In this case, the processor 110 may output, for example, a fourth output value including information that the wireless communication device 100 does not support the communication using the RF signal.

Referring to the above-described configurations, before allocating a port and a resource to each of the signals included in the RF signal, the processor 110 may determine whether the wireless communication device 100 is capable of supporting the communication using the RF signal, based on frequency information included in the RF signal and a predetermined set value.

Thus, the wireless communication device 100 according to the present embodiment may reduce power and resources consumed to determine whether the processor 110 is capable of allocating a ports and a resources to each of the signals included in the RF signal.

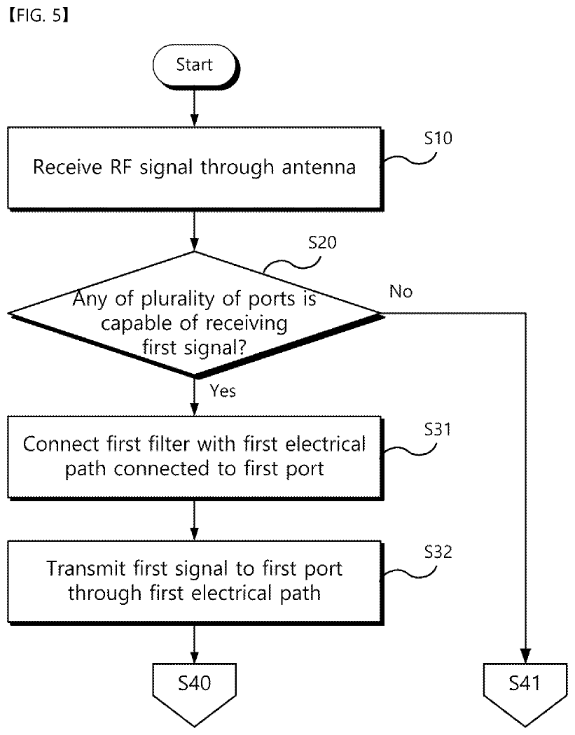

FIG. 5 is a flowchart illustrating an operation in which a wireless communication device according to an example embodiment controls a switching circuit to connect a first filter, through which a first signal passes, and a first electrical path connected to a first port.

Referring to FIGS. 2A and 5 together, the processor 110 according to an example embodiment may control the switching circuit 231 to transmit signals, respectively output from the plurality of filters 251, 252, and 253, to a portion of the plurality of ports P1, P2, P3, and P4.

However, at least a portion of the operations illustrated in FIG. 5 may be referred to as the same as the operations illustrated in FIG. 3A. Accordingly, the same reference numerals are used for the same or substantially the same components as described above, and redundant descriptions are omitted.

For example, the processor 110 may control the switching circuit 231 to connect the plurality of filters 251, 252, and 253 to an electrical path connected to a port capable of receiving a signal output from each filter.

In operation S31, the processor 110 may control the switching circuit 231 to connect the first filter 251 to the first electrical path 181 connected to the first port P1.

For example, the processor 110 may control the switching circuit 231 to connect the first filter 251 to an electrical path connected to a port capable of receiving the first signal.

For example, when it is determined that the first port P1 is capable of receiving the first signal, the processor 110 may control the switching circuit 231 to connect the first filter 251, outputting the first signal, to the first electrical path 181 connected to the first port P1.

For example, when it is determined that there is the third port P3 capable of receiving the first signal, the processor 110 may control the switching circuit 231 to connect the first filter 251, outputting the first signal, to the third electrical path connected to the third port P3.

For example, when there is a port capable of receiving the first signal, the processor 110 may connect a filter, outputting the first signal, to an electrical path connected to a port capable of receiving the first signal.

In operation S32, the processor 110 may transmit the first signal to the first port P1 through the first electrical path 181.

For example, when the first filter 251 and the first electrical path 181 are connected through the switching circuit 231, the processor 110 may transmit the first signal to the first port P1 through the first electrical path connected to the first port P1.

Accordingly, the processor 110 may receive the first signal, output through the first filter 251, through the first electrical path 181 and the first port P1.

Referring to the above-described configurations, the processor 110 may control the switching circuit 231 to transmit each of the signals included in the RF signal to a port, capable of receiving the signal, among the plurality of ports P1, P2, P3, and P4 included in the RFIC 130.

Thus, the wireless communication device 100 according to the present embodiment may increase the number of frequency bands, capable of supporting carrier aggregation (CA), and the number of combinations of the frequency bands.

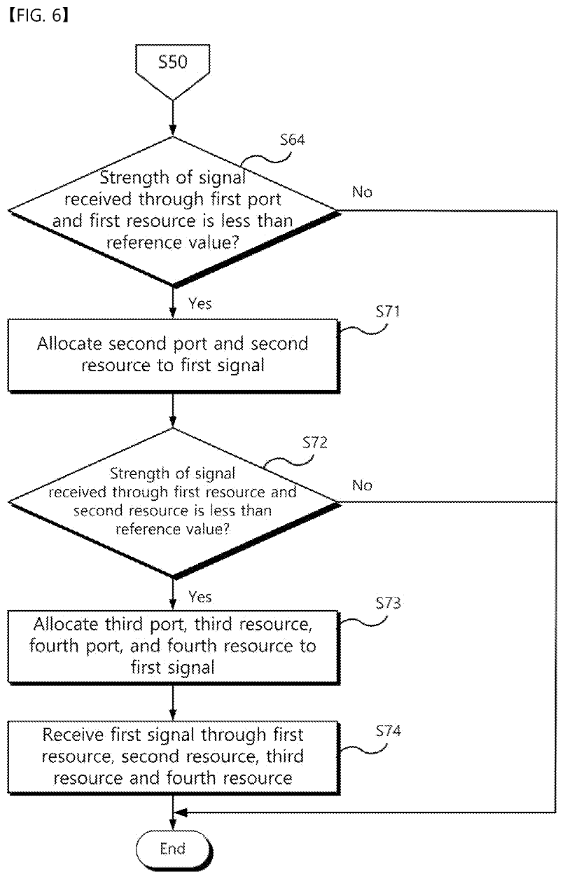

FIG. 6 is a flowchart illustrating an operation of allocating first to fourth ports and first to fourth resources to an RF signal having an additional path component, according to an example embodiment.

Referring to FIG. 6, the processor 110 according to an example embodiment may allocate at least two of the plurality of ports P1, P2, P3, and P4 to a signal including an additional path component. Moreover, the processor 110 may allocate at least two of the plurality of resources R1, R2, R3, and R4, connected to the allocated ports, to a signal including an additional path component.

For example, when strength of a signal received through a specific port and a specific resource is less than a threshold value, the processor 110 may allocate an additional port and an additional resource to a signal, including an additional path component, among signals include in the RF signal.

According to an example embodiment, at least a portion of the signals included in the RF signal may include an additional path (for example, a 4RX path) component. An example will be provided below, in which a first signal included in the RF signal includes an additional path component.

In operation S64, a processor 110 may determine whether strength of a signal received through a first port P1 and a first resource R1 is less than a reference value.

For example, when the first port P1 and the first resource R1 are allocated to the first signal, the processor 110 may determine whether the strength of the first signal received through the first port P1 and the first resource R1 is less than the reference value.

In this case, the reference value may be referred to as minimum strength of the first signal allowing a wireless communication device 100 to communicate with a base station (or another wireless communication device) through the first signal, but example embodiments are not limited thereto.

In operation S71, the processor 110 may allocate a second port P2 and a second resource R2 to the first signal.

For example, when the strength of the first signal received through the first port P1 and the first resource R1 is less than the reference value, the processor 110 may allocate the second port P2 and the second resource R2, in addition to the first port P1 and the first resource R1, to the first signal.

In operation S72, the processor 110 may determine whether strength of a signal received through the first resource R1 and the second resource R2 is less than the reference value.

For example, when the second port P2 and the second resource R2 are allocated to the first signal, the processor 110 may determine whether the strength of the signal received through the first port P1, the first resource R1, the second port P2, and the second resource R2 is less than the reference value.

In operation S73, the processor 110 may allocate a third port P3, a third resource R3, a fourth port P4, and a fourth resource R4 to the first signal.

For example, when strength of a signal received through the first resource R1 and the second resource R2 is less than the reference value, the processor 110 may additionally allocate the third port P3, the third resource R3, the fourth port P4, and the fourth resource R4 to the first signal based on the additional path component.

According to an example embodiment, when the strength of the signal received through the first resource R1 and the second resource R2 is less than the reference value, the processor 110 may additionally allocate the third port P3 and the third resource R3 to the first signal.

Moreover, when the strength of the signal received through the first resource R1, the second resource R2, and the third resource R3 is less than the reference value, the processor 110 may additionally allocate the fourth port P4 and the fourth resource R4 to the first signal.

In operation S74, the processor 110 may receive the first signal through the first resource R1, the second resource R2, the third resource R3, and the fourth resource R4.

For example, the processor 110 may receive the first signal through the first port P1 and the first resource R1, the second port P2 and the second resource R2, the third port P3 and the third resource R3, and the fourth port P4 and the fourth resource R4.

Moreover, when strength of the signal received through the first resource R1, the second resource R2, the third resource R3, and the fourth resource R4 is greater than or equal to the reference value, the processor 110 may determine that the wireless communication device 100 supports communication using the first signal.

In this case, the processor 110 (or the wireless communication device 100) may output an output value including information that the wireless communication device 100 supports the communication using the first signal.

On the other hand, when the strength of the signal received through the first resource R1, the second resource R2, the third resource R3, and the fourth resource R4 is less than the reference value, the processor 110 may determine that the wireless communication device 100 does not support the communication using the first signal.

In this case, the processor 110 (or the wireless communication device 100) may output an output value including information that the wireless communication device 100 does not support the communication using the first signal.

Referring to the above-described configurations, when the strength of the first signal received through a port and a resource allocated to the first signal is less than the reference value, the processor 110 may additionally allocate a port and a resource, included in the RFIC 130, to receive the first signal.

For example, the processor 110 may additionally allocate a port and a resource allocable to the RF signal to receive the RF signal.

Thus, the wireless communication device 100 according to the present example may reduce resources and power consumed to determine whether the wireless communication device 100 supports communication using a signal, including an additional path component, among signals of an RF signal based on carrier aggregation (CA).

As described above, the processor 110 according to an example embodiment may determine whether an RF signal, including signals in a plurality of frequency bands, is capable of being received based on carrier aggregation (CA). Thus, the processor 110 may determine whether the wireless communication device 100 is capable of supporting the communication using the RF signal including signals in a plurality of frequency bands.

With the above-described configurations, the wireless communication device 100 according to example embodiments may save costs and resources consumed to determine whether the wireless communication device 100 is capable of supporting communication including an RF signal including signals in a plurality of frequency bands.

In addition, the wireless communication device 100 according to example embodiments may save a storage space of a memory required to store data for determining whether the wireless communication device 100 is capable of supporting the communication using RF signals including signals in a plurality of frequency bands.

In addition, before allocating a port and a resource to each of the signals included in the RF signal, the processor 110 according to an example embodiment may determine whether the wireless communication device 100 is capable of supporting the communication using the RF signal, based on frequency information and a predetermined set value included in the RF signal.

Thus, the wireless communication device 100 according to example embodiments may reduce power and resources consumed to determine whether the processor 110 is capable of allocating a port and a resource to each of the signals included in the RF signal.

In addition, the processor 110 according to an example embodiment may control the switching circuit 231 to transmit each of the signals included in the RF signal to a port, capable of receiving the signal, among a plurality of ports P1, P2, P3, and P4 included in the RFIC 130.

Thus, the wireless communication device 100 according to example embodiments may increase the number of supportable frequency bands and the number of combinations of the frequency bands when supporting carrier aggregation (CA).

In addition, the processor 110 according to an example embodiment may additionally allocate a port and a resource, allocable to the RF signal.

Thus, the wireless communication device 100 according to example embodiments may reduce resources and power consumed to determine whether it supports communication using a signal including an additional path component, among signals of an RF signal based on carrier aggregation (CA).

As set forth above, according to example embodiments, a wireless communication device may allocate a port and a resource to a signal corresponding to each of a plurality of frequency bands to determine whether it supports a radio-frequency (RF) signal including corresponding signals.

Accordingly, the wireless communication device may save costs and resources consumed to determine whether it supports the RF signal.

It will be apparent to those skilled in the art that modifications and variations could be made to embodiments without departing from the scope of the appended claims.

What is claimed is:

1. A wireless communication device comprising:
a radio-frequency front end (RFFE) configured to receive an RF signal, comprising signals respectively corresponding to a plurality of frequency bands, through carrier aggregation;
a radio-frequency integrated circuit (RFIC) configured to receive the signals from the RFFE through at least a portion of a plurality of electrical paths and a plurality of ports connected to the plurality of electrical paths; and
at least one processor electrically connected to the RFIC and the RFFE,
wherein the at least one processor is configured to:
determine whether there is a port, capable of receiving a first signal corresponding to a first frequency band, among the signals, in the RFIC;
allocate a first port, capable of receiving the first signal, to the first signal based on the first port being available;
determine whether there is a resource, capable of receiving the first signal, among at least one resource connected to the first port; and
allocate a first resource, capable of receiving the first signal, to the first signal based on the first resource being available.

2. The wireless communication device of claim 1, wherein the at least one processor is further configured to:
determine that the wireless communication device does not support communication using the RF signal, based on no port, capable of receiving the first signal, being available among the plurality of ports; and
determine that the wireless communication device does not support the communication using the RF signal, based on no resource, capable of receiving the first signal, being available among the at least one resource connected to the first port allocated to the first signal.

3. The wireless communication device of claim 1, wherein the at least one processor is further configured to receive the first signal using the first port and the first resource in response to allocating the first port and the first resource to the first signal.

4. The wireless communication device of claim 2, wherein the at least one processor is further configured to:
allocate a port and a resource to each of the signals of the RF signal, other than the first signal, in response to allocating the first port and the first resource to the first signal; and
determine that the wireless communication device supports communication using the RF signal, in response to allocating a port and a resource to each of the signals included in the RF signal.

5. The wireless communication device of claim 1, further comprising a memory configured to store a set value associated with the RFIC, wherein the set value is predetermined, and
wherein the at least one processor is further configured to:
determine whether the RF signal is capable of being received through the RFIC, based on frequency information included in the RF signal and the set value stored in the memory, and
determine whether there is a port, capable of receiving the first signal included in the RF signal, among the plurality of ports, based on the RFIC being capable of receiving the RF signal.

6. The wireless communication device of claim 5, wherein the set value comprises at least one of a first number of the plurality of ports included in the RFIC, a second number of resources included in the RFIC, a frequency band capable of being received through the RFIC, and an indication of whether the RFIC supports additional path allocation.

7. The wireless communication device of claim 1, wherein the RFFE comprises a switching circuit electrically connected to the plurality of electrical paths, and
wherein the at least one processor is further configured to control the switching circuit to transmit the first signal to the first port through an electrical path, connected to the first port, among the plurality of electrical paths.

8. The wireless communication device of claim 1, wherein the at least one processor is further configured to:
allocate a second electrical path, a second port electrically connected to the second electrical path, and a second resource connected to the second port to the first signal, based on an additional path component included in the first signal, based on a strength of a signal received through the first port and the first resource is less than a predetermined reference value; and
receive the RF signal through the first resource and the second resource.

9. The wireless communication device of claim 8, wherein the at least one processor is further configured to:
allocate a third resource connected to a third port and a fourth resource connected to the fourth port to the first signal, based on the additional path component, based on a second strength of a second signal received through the first resource and the second resource being less than a reference value; and
receive the RF signal through the first resource, the second resource, the third resource, and the fourth resource.

10. The wireless communication device of claim 1, wherein the at least one resource comprises an amplifier, a mixer, and a local oscillator.

11. A wireless communication method comprising:
receiving a radio-frequency (RF) signal comprising signals, the signals respectively corresponding to a plurality of frequency bands;
determining whether there is a port, capable of receiving a first signal included in the RF signal, among a plurality of ports included in a radio-frequency integrated circuit (RFIC), in response to transmitting the first signal from a radio-frequency front end (RFFE) to the RFIC;
allocating a first port to the first signal based on there is the first port, capable of receiving the first signal, among the plurality of ports;
determining whether there is a resource, capable of receiving the first signal, among at least one resource connected to the first port; and
allocating a first resource to the first signal based on the first resource, capable of receiving the first signal, being available among the at least one resource.

12. The wireless communication method of claim 11, further comprising determining that a wireless communication device does not support communication using the RF signal, based on there being no port, capable of receiving the first signal, available among the plurality of ports or based on there being no resource, capable of receiving the first signal, available among at least one second resource connected to the first port allocated to the first signal.

13. The wireless communication method of claim 11, further comprising receiving the first signal using the first port and the first resource in response to allocating the first port and the first resource to the first signal.

14. The wireless communication method of claim 12, further comprising:
allocating a port and a resource to each of signals, other than the first signal, of the RF signal in response to allocating the first port and the first resource to the first signal; and
determining that the wireless communication device supports the communication using the RF signal, in response to allocating a port and a resource to each of the signals included in the RF signal.

15. The wireless communication method of claim 11, further comprising:
determining whether the RF signal is capable of being received through the RFIC, based on frequency information included in the RF signal and a set value previously stored in a memory, in response to receiving the RF signal;
determining that a wireless communication device does not support communication using the RF signal, when the RF signal is incapable of being received through the RFIC; and
determining whether there is a port, capable of receiving the first signal included in the RF signal, among the plurality of ports, when the RF signal is capable of being received through the RFIC.

16. The wireless communication method of claim 15, wherein the set value comprises at least one of a first number of the plurality of ports included in the RFIC, a second number of resources included in the RFIC, a frequency band capable of being received through the RFIC, and an indication of whether the RFIC supports additional path allocation.

17. The wireless communication method of claim 11, wherein the allocating the first port to the first signal comprises:
controlling a switching circuit included in the RFFE to connect a first filter, through which the first signal passes, to the first port; and
transmitting the first signal to the first port through a first electrical path.

18. The wireless communication method of claim 15, further comprising:
allocating a second electrical path, a second port connected to the second electrical path, and a second resource connected to the second port to the first signal, based on a first signal strength received through the first port and the first resource being less than a predetermined reference value;
allocating a third resource connected to a third port and a fourth resource connected to a fourth port to the first signal, based on an additional path component included in the first signal, responsive to a second signal strength received through the first resource and the second resource being less than a reference value; and
receiving the RF signal through the first resource, the second resource, the third resource, and the fourth resource.

19. A wireless communication device comprising:
a radio-frequency front end (RFFE) configured to receive an RF signal, comprising signals respectively corresponding to a plurality of frequency bands, through carrier aggregation;
a radio-frequency integrated circuit (RFIC) comprising a plurality of ports connected to the RFFE through a plurality of electrical paths; and
at least one processor electrically connected to the RFIC and the RFFE,
wherein the at least one processor is configured to:
allocate a first port, capable of receiving a first signal corresponding to a first frequency band, among the plurality of ports, to the first signal; and
allocate a first resource, capable of receiving the first signal, among at least one resource connected to the first port, to the first signal, wherein the first port is allocated to the first signal.

20. The wireless communication device of claim 19, wherein the at least one processor is further configured to:
receive the first signal using the first port and the first resource, wherein the first port and the first resource are allocated to the first signal; and
determine that the wireless communication device does not support communication using the RF signal, based on the plurality of ports and resources connected to the plurality of ports being unavailable for allocation to the first signal.
